(19) United States
(12) Patent Application Publication
(10) Pub. No.: US 2024/0223586 A1
(43) Pub. Date: Jul. 4, 2024

(54) SYSTEM AND METHOD FOR KERNEL-LEVEL ACTIVE DARKNET MONITORING IN A COMMUNICATION NETWORK

(71) Applicant: INDIAN INSTITUTE OF TECHNOLOGY KANPUR, KANPUR (IN)

(72) Inventors: Putrevu Venkata Sai Charan, Kanpur (IN); Gowtham Ratnakaram, Puttaparthi (IN); Sandeep Kumar Shukla, Kanpur (IN); Putrevu Mohan Anand, Kanpur (IN); Chunduri Naga Venkata Hrushikesh, Kanpur (IN)

(21) Appl. No.: 18/322,626

(22) Filed: May 24, 2023

Related U.S. Application Data
(60) Provisional application No. 63/478,196, filed on Jan. 3, 2023.

(51) Int. Cl. H04L 9/40

(52) U.S. Cl. CPC H04L 63/1425; H04L 63/0236; H04L 63/1416

(57) ABSTRACT

A system and method for kernel-level active darknet monitoring in a communication network is disclosed. The system receives TCP packets from initiator devices and determines dark internet protocol (IP) addresses in the packets by comparing destination IP address with a plurality of IP addresses stored in a dark IP pool. If the packets are determined to be destined for dark IP addresses, the system modifies flag and type in socket buffer and routing entry associated with packets. The system retrieves outbound interface IP addresses and creates a socket corresponding to the retrieved outbound interface IP addresses, for transmitting a SYN-ACK packet corresponding to the TCP packets. The system is configured to monitor dark IP addresses received through network traffic. Finally, the system outputs the SYN-ACK packet to initiator devices to establish a three-way handshake. The system receives an ACK from initiator devices (attackers) to establish a 3-way handshake.

### CROSS REFERENCE TO RELATED APPLICATION(S)

This application claims the priority to incorporates by reference the entire disclosure of U.S. provisional patent application No. 63/478,196, filed on Jan. 3, 2023, titled “System and Method For A Kernel-Level Active Darknet Monitoring Sensor For Gathering Organization-Specific Threat Intelligence”.

### TECHNICAL FIELD

Embodiments of the present disclosure generally relate to threat intelligence gathering systems and more particularly relates to a system and method for kernel-level active darknet monitoring in a communication network.

### BACKGROUND

Generally, in the field of cybersecurity, threat intelligence is crucial for understanding and mitigating targeted cyber-attacks that are becoming more prevalent. Traditional sources of threat intelligence such as independent security researchers, vendor blogs, and published threat indicator blocklists may not be helpful in comprehending an organization's specific threat landscape. Private or commercial threat intelligence feeds may offer more relevant information, but they do not provide the complete picture. In recent years, monitoring Darknet data has become a valuable source of threat information at the enterprise level. Darknet refers to a collection of Internet Protocol (IP) addresses allotted to an organization but not assigned to any specific host. Traffic destined for these unassigned IP addresses is considered suspicious and serves as a valuable source for threat intelligence.

Currently, darknet monitoring can be performed in either passive or active mode. Passive monitoring provides generic information without actively engaging with the attacker devices. However, it is infeasible to perform active attacker scanning with existing passive darknet monitoring sensors. In contrast, active darknet monitoring engages with the initiator of communication, which allows for validation of the source IP of incoming packets. This type of monitoring is essential for capturing organization-specific threat intelligence. Cyber Threat Intelligence (CTI) plays a critical role in providing evidence-based knowledge to plan defensive strategies against advanced cyber-attacks. Further a plurality of threat intelligence data originates from security researchers, vendor blogs, list of threat indicators, and commercial cyber security firms. However, as attack surfaces become more dynamic and threat actors shift towards organization/sector-specific attacks, generic threat information is no longer adequate to safeguard against these targeted attacks. In such scenarios, darknet data can be an invaluable source of threat information at the enterprise level as in darknet, the traffic is destined for a range of unused IP addresses.

The term “darknet” refers to a collection of Internet Protocol (IP) addresses allotted to the organization but not assigned to any specific host. For example, an IPV4 address range allotted to a particular university as an organization is 202.3.XX.0-202.3.XX.255. However, not all 256 addresses in this range have been assigned to a real machine and remain unused. An attacker might try to scan the entire range of IPV4 addresses by sending handshaking packets to all the addresses in order to determine network structure, applications running on the machines at those addresses, or to find the open ports and the like. If an address is assigned to a machine, depending on that machine's firewall setting, the machine might respond to these probing packets. However, IP addresses not assigned to a machine remain un-responded. The traffic destined to such unassigned IP addresses is called Darknet traffic. Attackers often use spoofed source IP addresses while sending probing packets. In such cases, even if the probe packet is responded to, the handshake never completes. On the other hand, if an attacker is using a real source IP address in its probe packets, then the handshake is completed by responding to the probe packets.

In the passive approach, the darknet sensor does not communicate with the initiator of the communication. The captured traffic, therefore, consists mainly of the first request for communication. In addition, passive darknet monitoring is ineffective during attacks such as distributed reflection denial of service (DRDoS), denial of service (DOS), and SYN-flood as inbound TCP SYN packets on the entire darknet originate from spoofed IP addresses. Consequently, there will be a drain on resources in terms of storage space and time spent on data preprocessing and analysis. Therefore, passive monitoring hinders threat intelligence and fragments darknet data without providing genuine attack insights.

Further, cyber risks have developed rapidly as a major concern in the public sector, banking, energy, medical, and education sectors are particularly vulnerable to cyber-attacks. Due to the evolving nature of targeted cyber-attacks, effective utilization of targeted threat intelligence is necessary for an in-depth comprehension of attackers and their methods. Threat intelligence is gathered from various sources and monitoring unused IP addresses (darknet) is a widely known method. The darknet monitoring is performed in either active or passive mode. However, passive darknet monitoring provides a generic information without active engagement with the attacker's devices.

Therefore, there is a need for an improved system and method for kernel-level active darknet monitoring in a communication network, to capture organization-specific threat intelligence in active darknet monitoring mode, for addressing at least the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a system for kernel-level active darknet monitoring in a communication network. The system receives one or more transmission control protocol (TCP) packets from one or more initiator devices. The one or more TCP packets comprises a synchronize packet (TCP-SYN) to initiate a connection with system and establish a communication channel. Further, the system determines one or more dark internet protocol (IP) address in the received one or more TCP packets, by comparing a destination IP address of the received one or more TCP packets with a plurality of IP addresses stored in a dark IP pool. Furthermore, the system modifies, in a socket buffer, at least one of a flag to a local flag and a type to a local type corresponding to the received one or more TCP packets, when each of the one or more TCP packets is determined to be destined for each of one or more dark IP addresses. Additionally, the system modifies at least one of the flag to the local flag and the type to the local type corresponding to a routing entry associated with the socket buffer in a packet header corresponding to the one or more TCP packets, when the one or more TCP packets is determined to be destined for the one or more dark IP addresses. Further, the system retrieves an outbound interface IP address by circumnavigating a hash value comparison of network interface IP addresses with destination IP addresses assigned in the one or more TCP packets. Furthermore, the system creates a socket corresponding to the retrieved outbound interface IP address, for transmitting a synchronize-acknowledgement (SYN-ACK) packet corresponding to the one or more TCP packets, based on the circumnavigation. The system 102 is configured to monitor each of one or more dark IP addresses received through a network traffic, based on modifying at least one of the flag to the local flag and the type to the local corresponding to the one or more TCP packets determined to be destined for the one or more dark IP addresses. The socket serves as an endpoint within a two-way communication connection established between two software programs. The socket is associated with a specific port number, which enables the Transmission Control Protocol (TCP) layer to accurately identify an intended recipient application for data transmission. Additionally, the system outputs the SYN-ACK response packet to the one or more initiator devices. The one or more initiator devices establish the communication channel by transmitting an acknowledgement (ACK) packet to the system to establish a three-way handshake.

An aspect of the present disclosure provides a method for kernel-level active darknet monitoring in a communication network. The method includes receiving one or more transmission control protocol (TCP) packets from one or more initiator devices. The one or more TCP packets comprises a synchronize packet (TCP-SYN) to initiate a connection with the system and establish a communication channel. Further, the method includes determining one or more dark internet protocol (IP) address in the received one or more TCP packets, by comparing a destination IP address of the received one or more TCP packets with a plurality of IP addresses stored in a dark IP pool. Furthermore, the method includes modifying in a socket buffer, at least one of a flag to a local flag and a type to a local type corresponding to the received one or more TCP packets, when each of the one or more TCP packets is determined to be destined for each of one or more dark IP addresses. Further, the method includes modifying at least one of the flag to the local flag and the type to the local type corresponding to a routing entry associated with the socket buffer in a packet header corresponding to the one or more TCP packets, when the one or more TCP packets is determined to be destined for the one or more dark IP addresses. Furthermore, the method includes retrieving outbound interface IP addresses by circumnavigating a hash value comparison of network interface IP addresses with destination IP addresses assigned in the one or more TCP packets. Additionally, the method includes creating a socket corresponding to the retrieved outbound interface IP addresses, for transmitting a synchronize-acknowledgement (SYN-ACK) packet corresponding to the one or more TCP packets, based on the circumnavigation. The system is configured to monitor each of one or more dark IP addresses received through a network traffic, based on modifying at least one of the flags to the local flag and the type to the local corresponding to the one or more TCP packets determined to be destined for the one or more dark IP addresses. Further, the method includes outputting the SYN-ACK packet to the one or more initiator devices. The one or more initiator devices establish the communication channel by transmitting an acknowledgement (ACK) packet to the system to establish a three-way handshake.

Yet another aspect of the present disclosure provides a non-transitory computer-readable storage medium having programmable instructions stored therein. That when executed by one or more hardware processors, cause the one or more hardware processors to receive one or more transmission control protocol (TCP) packets from one or more initiator devices. The one or more TCP packets comprises a synchronize packet (TCP-SYN) to initiate a connection with the system and establish a communication channel. Further, the one or more hardware processors determine one or more dark internet protocol (IP) address in the received one or more TCP packets, by comparing a destination IP address of the received one or more TCP packets with a plurality of IP addresses stored in a dark IP pool. Furthermore, the one or more hardware processors modify, in a socket buffer, at least one of a flag to a local flag and a type to a local type corresponding to the received one or more TCP packets, when each of the one or more TCP packets is determined to be destined for each of one or more dark IP addresses. Additionally, the one or more hardware processors modify at least one of the flag to the local flag and the type to the local type corresponding to a routing entry associated with the socket buffer in a packet header corresponding to the one or more TCP packets, when the one or more TCP packets is determined to be destined for the one or more dark IP addresses. Further, the one or more hardware processors retrieve outbound interface IP addresses by circumnavigating a hash value comparison of network interface IP addresses with destination IP addresses assigned in the one or more TCP packets. Furthermore, the one or more hardware processors create a socket corresponding to the retrieved outbound interface IP addresses, for transmitting a synchronize-acknowledgement (SYN-ACK) packet corresponding to the one or more TCP packets, based on the circumnavigation. The system is configured to monitor each of one or more dark IP addresses received through a network traffic, based on modifying at least one of the flag to the local flag and the type to the local corresponding to the one or more TCP packets determined to be destined for the one or more dark IP addresses. Additionally, the one or more hardware processors output the SYN-ACK packet to the one or more initiator devices. The one or more initiator devices establish the communication channel by transmitting an acknowledgement (ACK) packet to the system to establish a three-way handshake.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an exemplary block diagram representation of a network architecture implementing a system for kernel-level active darknet monitoring in a communication network, in accordance with an embodiment of the present disclosure;

FIG. 2 illustrates an exemplary block diagram representation of a computer-implemented system, such as those shown in FIG. 1, capable of kernel-level active darknet monitoring in a communication network, in accordance with an embodiment of the present disclosure;

FIG. 3 illustrates an exemplary flow diagram representation of a method for modifying flag and type associated with a socket buffer to process incoming transmission control protocol (TCP) packets, in accordance with the embodiment of the present disclosure;

FIG. 4A illustrates an exemplary schematic diagram representation of implementing darknet kernel in an organization, in accordance with the embodiment of the present disclosure;

FIG. 4B illustrates an exemplary flow diagram representation of a method for obtaining threat Intelligence from an implemented dark kernel in an organization, in accordance with the embodiment of the present disclosure;

FIGS. 4C-4E illustrate exemplary schematic diagram representations of attack timelines for a plurality of exemplary scenarios, in accordance with the embodiment of the present disclosure;

FIG. 4F illustrates an exemplary timing diagram representation of a darknet kernel operation and transmission control protocol (TCP) states, in accordance with the embodiment of the present disclosure:

FIG. 5 illustrates a flow chart depicting a method for kernel-level active darknet monitoring in a communication network, in accordance with the embodiment of the present disclosure; and

FIG. 6 illustrates an exemplary block diagram representation of a hardware platform for an implementation of the disclosed system, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client, or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or s “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments of the present disclosure provide a system and a method for kernel-level active darknet monitoring in a communication network. The present disclosure provides a system for collecting organization-specific threat intelligence. The present disclosure provides a system and a method for dark internet protocol (IP) lookup and store a group of IP addresses in a hexadecimal byte order. The present disclosure provides a system and method for providing a modified network stack at the kernel level to process one or more incoming transmission control protocol (TCP) packets. The modified kernel network stack module is configured to use a dark IP look up computing module several times while routing a plurality of packets destined for addresses present in dark IP pool. The modified kernel network stack is further configured to enable packets destined for a range of unused IP addresses (dark IP) as local IP addresses. The modified kernel network stack is also configured to complete a 3-way handshake (synchronize (SYN), synchronize-acknowledgement (SYN-ACK), and acknowledgement (ACK)). The present disclosure provides a system and method to validate a plurality of sources of a plurality of active attackers in real-time by actively engaging in the 3-way handshake. The present disclosure provides a system and method for segregating a backscattered traffic and an active attacker scanning, which is infeasible with existing passive darknet monitoring sensors.

Further, the present disclosure provides a proactive approach to detect and engage external threat actors who perform scanning activity on a wide network range. The engagement is achieved by establishing the 3-way handshake. The present disclosure creates a phantom responder that mimics the behavior of active machines, thereby tricking attackers into performing malicious operations on unused IP addresses, in an attempt to compromise the organization's infrastructure. This enables the organization to gather critical threat intelligence by identifying the attackers' identity and modus operandi in real-time. The kernel-level active darknet monitoring system deployed within the organization's network provides a comprehensive solution to detect and monitor threat actors, protocols, and services they target, thus enhancing the organization's cybersecurity defenses.

Furthermore, the present disclosure is tailored to meet the needs of organizations that require organization-specific threat intelligence. The system can identify the most vulnerable parts of the organization's data and infrastructure by monitoring and analyzing the operation of threat actors and the services they target. This facilitates the development of improved cyber defense mechanisms, enabling the organization to identify services that attackers are actively trying to compromise in real-time. The system can be optimized to design a lightweight active darknet sensor for low-memory devices, thereby providing an effective and ideal solution for both large and small-scale organizations. The system may be deployed as a service, and certain components can be modified as per the organization's network requirements to ensure optimal performance, depending on the bandwidth of the darknet traffic and the number of unused IP addresses available.

As used herein, the term “threat intelligence” is defined as a data that is collected, processed, and analyzed to understand a threat actor's motives, targets, and attack behaviors. Threat intelligence enables us to make faster, more informed, data-backed security decisions and change their behavior from reactive to proactive in the fight against threat actors. The term “organization specific threat intelligence” is defined as the landscape of cyber-attacks is shifting faster, and attackers are moving towards targeted or organization-specific attacks. For example, attackers operate differently to target different sectors such as defense, health care, finance, critical infrastructure and the like. Hence, an effective utilization of targeted threat intelligence is necessary for an organization for in-depth comprehension of the attackers and method of the attackers. This is referred to as organization specific threat intelligence.

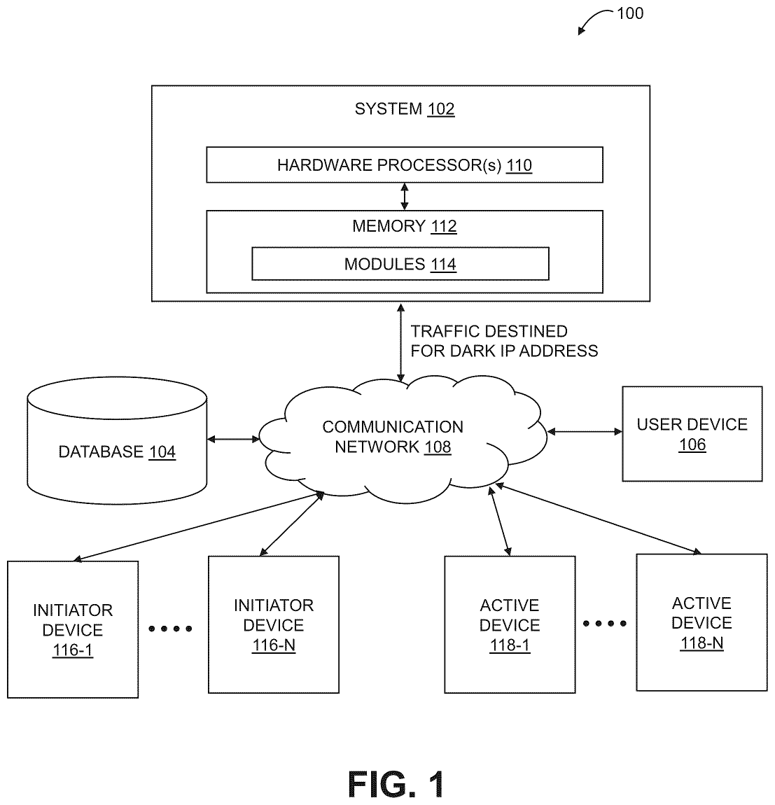

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 implementing a system 102 for kernel-level active darknet monitoring in a communication network 108, in accordance with an embodiment of the present disclosure. According to FIG. 1, the network architecture 100 may include the system 102, a database 104, a user device 106, one or more initiator devices 116-1, . . . , 116-N (individually referred to as the initiator device 116 and collectively referred to as the initiator devices 116), and one or more active devices 118-1, . . . , 118-N (individually referred to as the active device 118 and collectively referred to as the active devices 118). The system 102 may be communicatively coupled to the database 104, and the user device 106 via a communication network 108. The communication network 108 may be a wired communication network and/or a wireless communication network. The database 104 may include, but is not limited to, dark internet protocol (IP) addresses, unused IP addresses, intelligence reports, plurality of IP addresses, hash values, modus operandi data, modus operandi report, packet capture (PCAP) data, alerts, port data, prolific ports data, threat intelligence data, network protocols, source IP addresses, destination IP addresses, outbound interface IP addresses, network interface IP addresses, port numbers, and payload of the one or more transmission control protocol (TCP) packets, attack patterns, flags, types, synchronize-acknowledgement (SYN-ACK) packet, one or more geolocations of the one or more initiator devices 116 (attackers), engagement time of the one or more dark IP addresses, one or more warnings corresponding to the profiled one or more attacks, a plurality of threat levels, any other data, and combinations thereof. The database 104 may be any kind of database such as, but are not limited to, relational databases, dynamic databases, monetized databases, scalable databases, cloud databases, distributed databases, any other databases, and combination thereof.

Further, the user device 106 may be associated with, but not limited to, a user, an individual, an administrator, a vendor, a technician, a worker, a specialist, an instructor, a supervisor, a team, an entity, an organization, a company, a facility, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for the kernel-level active darknet monitoring needs. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for kernel-level active darknet monitoring in a communication network. Execution of the machine-readable program instructions by the hardware processor 110 may enable the proposed system 102 to kernel-level active darknet monitoring in a communication network. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at different locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may receive one or more transmission control protocol (TCP) packets from one or more initiator devices 116. In an exemplary embodiment, the one or more TCP packets comprises a synchronize packet (TCP-SYN) to initiate a connection with the system 102 and establish a communication channel.

In an exemplary embodiment, the system 102 may determine one or more dark internet protocol (IP) address in the received one or more TCP packets, by comparing a destination IP address of the received one or more TCP packets with a plurality of IP addresses stored in a dark IP pool.

In an exemplary embodiment, the system 102 may modify, in a socket buffer (not shown in FIG. 1), at least one of a flag to a local flag and a type to a local type corresponding to the received one or more TCP packets, when each of the one or more TCP packets is determined to be destined for each of one or more dark IP addresses. The socket buffer (or “sockbuf” for short) is a data structure used by a computer's operating system to store data that is being transmitted over a network socket. A socket buffer is typically implemented as a ring buffer, which is a circular buffer that can wrap around from the end of the buffer to the beginning. As data is received from the network, it is stored in the socket buffer until it is read by the application that is using a socket. Similarly, as data is sent out over the communication network 108, it is copied into the socket buffer before being transmitted. Further, the size of the socket buffer is configurable, and can be adjusted by the operating system or by the application that is using the socket. A larger buffer can improve network performance by reducing the number of times that the application needs to read or write data to the socket, but it can also increase memory usage and delay the processing of the data.

In an exemplary embodiment, the system 102 may modify at least one of the flag to the local flag and the type to the local type corresponding to a routing entry associated with the socket buffer in a packet header corresponding to the one or more TCP packets, when the one or more TCP packets is determined to be destined for the one or more dark IP addresses.

In an exemplary embodiment, the system 102 may retrieve outbound interface IP addresses by circumnavigating a hash value comparison of network interface IP addresses with destination IP addresses assigned in the one or more TCP packets. For example, when data is transmitted over the communication network 108 using a transmission control protocol (TCP), each packet is assigned a unique identifier called a sequence number. When the receiving end (e.g., initiator devices 116) receives the packet, it uses the sequence number to ensure that the packets are received in the correct order and that none have been lost in transmission. The hash value is a unique fixed-length value that is computed from the contents of the packet. It is used to ensure that the packet has not been altered in transit and to detect errors in transmission. The term “circumnavigating” generally refers to finding a way around something, for example, bypassing the process of comparing destination IP address in the TCP packets with the network interface IP address. The function of circumnavigating may indicate that the system 102 deviates an expected protocol of dropping TCP packets destine for the dark IP addresses to avoid detection or for deceiving one or more dark IP addresses or active devices 118 to the initiator devices 116 attempting to connect to the dark IP addresses. At the TCP layer packet processing, while fetching the outbound interface for creating a socket, the kernel performs the hash comparison with network interface IP addresses with the destination IP address assigned in the packet. Based on the hash comparison, the corresponding outbound interface is chosen for sending the response packet. The kernel code is tweaked to fetch the default outbound interface by circumnavigating the hash comparison with the network interface IP addresses for creating the socket to send the response packet for the received request packet by the system 102.

In an exemplary embodiment, the system 102 may create a socket (not shown in FIG. 1) (interchangeably referred to as ‘socket’ or ‘network socket’) corresponding to the retrieved outbound interface IP addresses, for transmitting a synchronize-acknowledgement (SYN-ACK) packet corresponding to the one or more TCP packets, based on the circumnavigation. In an exemplary embodiment, the system is configured to monitor each of one or more dark IP addresses received through a network traffic, based on modifying at least one of the flag to the local flag and the type to the local corresponding to the one or more TCP packets determined to be destined for the one or more dark IP addresses.

In an exemplary embodiment, the system 102 may output the SYN-ACK to the one or more initiator devices 116, wherein the one or more initiator devices 116 establish the communication channel by transmitting an acknowledgement (ACK) packet to the system 102 to establish a three-way handshake. The three-way handshake is a process that establishes a reliable communication channel between one or more initiator devices 116 and the system 102 in the communication network 108. The three-way handshake may include synchronize (SYN), synchronize-acknowledge (SYN-ACK), and acknowledge (ACK) signal transmission. The SYN is a process, which starts when a device (e.g., initiator devices 116) sends a SYN packet to dark IP addresses requesting to establish a connection. This packet contains a sequence number that the initiator devices 116 chooses randomly, and it is used to synchronize the sequence numbers of both initiator devices 116 and the system 102. Furthermore, SYN-ACK is performed upon receiving the SYN packet, the system 102 responds with a SYN-ACK packet. This packet contains a sequence number that the system 102 chooses randomly, as well as an acknowledgement number that is the sequence number SYN packet plus one of the initiator devices 116. The SYN-ACK packet is a signal that the system 102 agrees to establish a connection with the initiator devices 116. Furthermore, in ACK, the initiator devices 116 sends an ACK packet to the system 102 which contains the acknowledgement number from SYN-ACK packet received from the system 102. This packet confirms that the initiator devices 116 received response from the system 102 and agrees to establish a connection. Once the system 102 receives the ACK packet, the connection is established, and both devices can start sending data to each other.

For example, consider the communication network 108 associated with an organization is assigned with hundred (100) IP addresses. Out of 100 IP addresses, for example, five (5) IP addresses are assigned to the active devices 118-1 to 118-N, other 95 IP addresses are unassigned/unused IP addresses (dark IP addresses) in the communication network 108. The IP addresses assigned to the active devices 118-1 to 118-N are dynamic and can change based on the requirement. For example, if IP address one (1) is assigned to active device 118-1, then based on requirement the IP address one (1) is unassigned first and IP address six (6) is assigned to the active device 118-1. In the system 102 (e.g., kernel) which is created, the unused IP addresses which are to be monitored are hardcoded in hexadecimal byte order in the system 102 (e.g., kernel). The dark IP addresses may not be stored in the database. As the IP addresses are unused, the system 102 should not receive any network traffic destined to the unused IP addresses. However, the one or more initiator devices 116 scan the unused IP addresses and send TCP-SYN packets to the unused IP addresses. The system 102 (e.g., kernel) may consider that the TCP-SYN packets destined for a range of dark IP addresses (unused IP addresses) as local packets and sends back SYN-ACK to the one or more initiator devices 116 and establishes 3-way handshake. Hence, the system 102 may segregate a spoofed network traffic and real attackers.

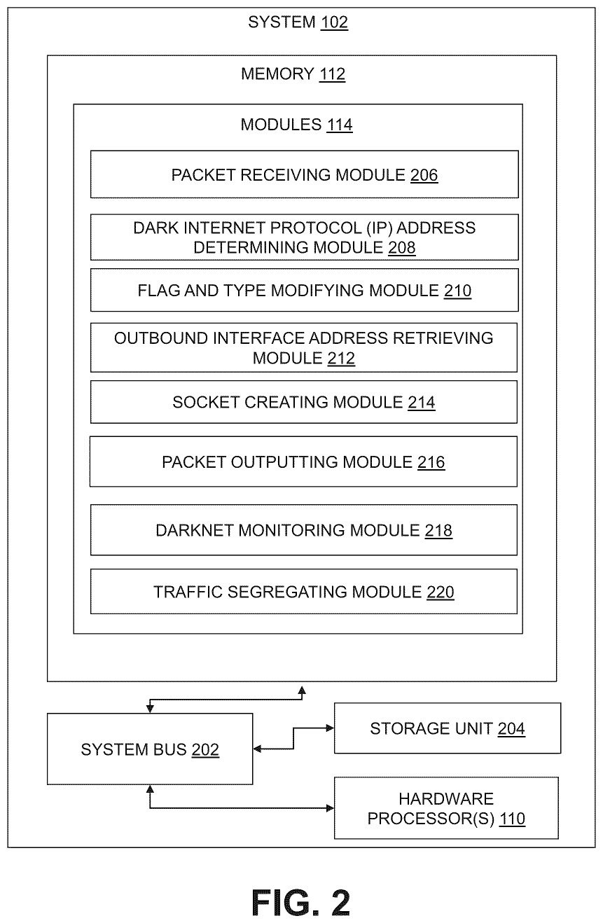

FIG. 2 illustrates an exemplary block diagram representation of a computer-implemented system 102, such as those shown in FIG. 1, capable of kernel-level active darknet monitoring in a communication network, in accordance with an embodiment of the present disclosure. The system 102 may also function as a computer-implemented system (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

Further, the plurality of modules 114 includes a packet receiving module 206, a dark internet protocol (IP) address determining module 208, a flag and type modifying module 210, an outbound interface address retrieving module 212, a socket creating module 214, a packet outputting module 216, a darknet monitoring module 218, and a traffic segregating module 220.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a database such as those shown in FIG. 1. The storage unit 204 may store, but is not limited to, dark internet protocol (IP) addresses, unused IP addresses, intelligence reports, plurality of IP addresses, hash values, modus operandi data, modus operandi report, packet capture (PCAP) data, alerts, port data, prolific ports data, threat intelligence data, network protocols, source IP addresses, destination IP addresses, outbound interface IP addresses, network interface IP addresses, port numbers, and payload of the one or more transmission control protocol (TCP) packets, attack patterns, flags, types, synchronize-acknowledgement (SYN-ACK) packet, one or more geolocations of the initiator devices 116, engagement time of the one or more initiator devices 116 (attackers) targeting one or more dark IP addresses, one or more warnings corresponding to the profiled one or more attacks, a plurality of threat levels, any other data, and combinations thereof. The storage unit 204 may be any kind of database such as, but are not limited to, relational databases, dynamic databases, monetized databases, scalable databases, cloud databases, distributed databases, any other databases, and combination thereof.

In an exemplary embodiment, the packet receiving module 206 may receive one or more transmission control protocol (TCP) packets from one or more initiator devices 116. In an exemplary embodiment, the one or more TCP packets comprises a synchronize packet (TCP-SYN) to initiate a connection with the system and establish a communication channel. In an exemplary embodiment, the dark internet protocol (IP) address determining module 208 may determine one or more dark internet protocol (IP) address in the received one or more TCP packets, by comparing a destination IP address of the received one or more TCP packets with a plurality of IP addresses stored in a dark IP pool.

In an exemplary embodiment, the flag and type modifying module 210 may modify, in a socket buffer (not shown in FIG. 2), at least one of a flag to a local flag and a type to a local type corresponding to the received one or more TCP packets, when each of the one or more TCP packets is determined to be destined for each of one or more dark IP addresses. The socket buffer (or “sockbuf” for short) is a data structure used by a computer's operating system to store data that is being transmitted over a network socket. A socket buffer is typically implemented as a ring buffer, which is a circular buffer that can wrap around from the end of the buffer to the beginning. As data is received from the network, it is stored in the socket buffer until it is read by the application that is using the socket. Similarly, as data is sent out over the communication network 108, it is copied into the socket buffer before being transmitted. Further, the size of the socket buffer is configurable, and can be adjusted by the operating system or by the application that is using the network socket. A larger buffer can improve network performance by reducing the number of times that the application needs to read or write data to the socket, but it can also increase memory usage and delay the processing of the data.

In an exemplary embodiment, the flag and type modifying module 210 may modify at least one of the flag to the local flag and the type to the local type corresponding to a routing entry associated with the socket buffer in a packet header corresponding to the one or more TCP packets, when the one or more TCP packets is determined to be destined for the one or more dark IP addresses. In an exemplary embodiment, the outbound interface address retrieving module 212 may retrieve outbound interface IP addresses by circumnavigating a hash value comparison of network interface IP addresses with destination IP addresses assigned in the one or more TCP packets. For example, when data is transmitted over the communication network 108 using a transmission control protocol (TCP), each packet is assigned a unique identifier called a sequence number. When the receiving end (e.g., initiator device 116) receives the packet, it uses the sequence number to ensure that the packets are received in the correct order and that none have been lost in transmission. The hash value is a unique fixed-length value that is computed from the contents of the packet. It is used to ensure that the packet has not been altered in transit and to detect errors in transmission. The term “circumnavigating” generally refers to finding a way around something, for example, bypassing the process of comparing destination IP address assigned in the TCP packets with the network interface IP address. The function of circumnavigating may indicate that the system 102 deviates an expected protocol of dropping TCP packets destine for the dark IP addresses to avoid detection or for deceiving one or more dark IP addresses or active devices 118 to the initiator devices 116 attempting to connect to the dark IP addresses.

In an exemplary embodiment, the socket creating module 214 may create a socket (not shown in FIG. 2) corresponding to the retrieved outbound interface IP addresses, for transmitting a synchronize-acknowledgement (SYN-ACK) packet corresponding to the one or more TCP packets, based on the circumnavigation. In an exemplary embodiment, the system 102 is configured to monitor each of one or more dark IP addresses received through a network traffic, based on modifying at least one of the flag to the local flag and the type to the local corresponding to the one or more TCP packets determined to be destined for the one or more dark IP addresses. The socket serves as an endpoint within a two-way communication connection established between two software programs. The socket is associated with a specific port number, which enables the Transmission Control Protocol (TCP) layer to accurately identify an intended recipient application for data transmission.

In an exemplary embodiment, the packet outputting module 216 may output the SYN-ACK packet to the one or more initiator devices 116. The one or more initiator devices 116 establish the communication channel by transmitting an acknowledgement (ACK) packet to the system 102 to establish a three-way handshake. The three-way handshake is a process that establishes a reliable communication channel between one or more initiator devices 116 and the system 102 in the communication network 108. The three-way handshake may include synchronize (SYN), synchronize-acknowledge (SYN-ACK), and acknowledge (ACK) signal transmission. The SYN is a process, which starts when a device (e.g., initiator devices 116) sends a SYN packet to dark IP addresses monitored by the system 102 requesting to establish a connection. This packet contains a sequence number that the initiator devices 116 chooses randomly, and it is used to synchronize the sequence numbers of both initiator devices 116 and the system 102.

Furthermore, SYN-ACK is performed upon receiving the SYN packet, the system 102 responds with a SYN-ACK packet. This packet contains a sequence number that the system 102 chooses randomly, as well as an acknowledgement number that is the sequence number SYN packet plus one of the initiator devices 116. The SYN-ACK packet is a signal that the system 102 agrees to establish a connection with the initiator devices 116. Furthermore, in ACK, the initiator devices 116 sends an ACK packet to the system 102, which contains the acknowledgement number from SYN-ACK packet received from the system 102. This packet confirms that the initiator devices 116 received response from the system 102 and agrees to establish a connection. Once the system 102 receives the ACK packet, the connection is established, and both devices can start sending data to each other. In an exemplary embodiment, to modify at least one of the flag to the local flag and the type to the local corresponding to the one or more TCP packets, the plurality of modules 114 comprises the darknet monitoring module 218 configured to kernel-level active darknet monitoring destined to the one or more dark IP addresses.

In an exemplary embodiment, the plurality of modules 114 further comprises the traffic segregating module 220 configured to segregate a backscattered traffic of the SYN-ACK packet and an active attacker in the one or more initiator devices 116. In an exemplary embodiment, the plurality of modules 114 further comprises an endpoint creating module (not shown in FIG. 2) configured to create one or more phantom responder endpoints to one or more attacks using the one or more dark IP addresses. In an exemplary embodiment, the plurality of modules 114 further comprises a machine simulating module (not shown in FIG. 2) configured to simulate active devices 118 corresponding to the active device 118 for sending the response packet. In an exemplary embodiment, the plurality of modules 114 further comprises an activity deception module (not shown in FIG. 2) configured to perform deception of the one or more initiator devices 116 performing a series of malicious operations in an attempt to compromise the one or more dark IP addresses using the simulated active devices 118. In an exemplary embodiment, the plurality of modules 114 further comprises a data accumulating module (not shown in FIG. 2) configured to accumulate pre-determined threat intelligence data corresponding to the one or more attacks by the one or more initiator devices 116, and a modus operandi data corresponding to the one or more attacks.

In an exemplary embodiment, to accumulate the modus operandi data corresponding to the one or more attacks, the plurality of modules 114 further comprises a data monitoring module (not shown in FIG. 2) configured to monitor packet capture (PCAP) data for determining one or more geo-locations of the one or more initiator devices 116. In an exemplary embodiment, the plurality of modules 114 further comprises a data analyzing module (not shown in FIG. 2) configured to analyze the data to identify attack patterns and a plurality of threat levels posed by the one or more initiator devices 116. In an exemplary embodiment, the plurality of modules 114 further comprises a report generating module (not shown in FIG. 2) configured to generate a modus operandi report corresponding to the identified attack patterns and the plurality of threat levels.

In an exemplary embodiment, the plurality of modules 114 further comprises a packet data accumulating module (not shown in FIG. 2) configured to accumulate PCAP data associated with the system 102 and the one or more initiator devices 116. In an exemplary embodiment, a data analyzing module (not shown in FIG. 2) may be configured to analyze the accumulated PCAP data using a network security analyzing technique. In an exemplary embodiment, an alert generating module (not shown in FIG. 2) may be configured to generate one or more alerts using the network security analyzing technique, based on the analyzed PCAP data. In an exemplary embodiment, a prioritized alert determining module (not shown in FIG. 2) may be configured to determine one or more prioritized alerts in the generated one or more alerts, for the active darknet monitoring. In an exemplary embodiment, the PCAP data comprises information corresponding to, but are not limited to, network protocols, source IP addresses, destination IP addresses, outbound interface IP addresses, network interface IP addresses, port numbers, payload of the one or more TCP packets, and the like.

In an exemplary embodiment, the plurality of modules 114 further comprises a geolocation mapping module (not shown in FIG. 2) configured to map one or more geolocations of the initiator devices 116 targeting one or more pre-defined ports associated with the dark IP addresses monitored by the system 102. In an exemplary embodiment, an engage-time calculating module (not shown in FIG. 2) may be configured to calculate an average engagement time of the one or more dark IP addresses with each of the one or more pre-defined ports (not shown in FIG. 2) of the one or more dark IP addresses. In an exemplary embodiment, an attack determining module (not shown in FIG. 2) may be configured to determine the one or more attacks based on the calculated average engagement time of the one or more initiator devices 116 with each of the one or more pre-defined ports of the one or more dark IP addresses. In an exemplary embodiment, an attacker profiling module (not shown in FIG. 2) may be configured to profile the one or more attacks from the one or more initiator devices 116 based on determining the one or more attacks. In an exemplary embodiment, a warning generating module (not shown in FIG. 2) may be configured to generate one or more warnings corresponding to the profiled one or more attacks.

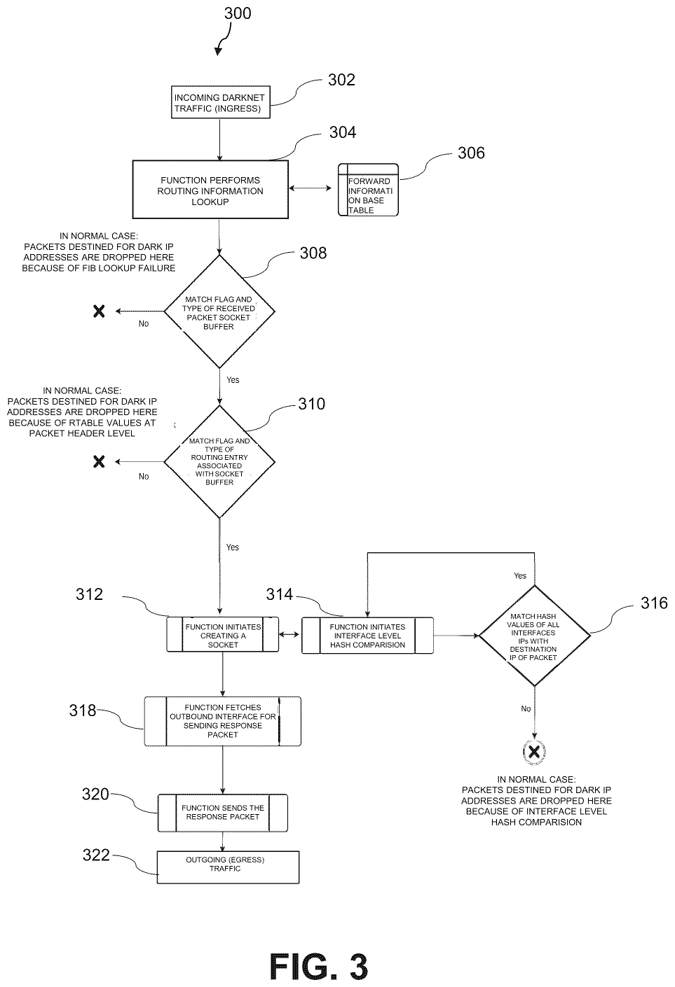

FIG. 3 illustrates an exemplary flow diagram representation of a method 300 for modifying a flag and a type associate the socket buffer to process incoming transmission control protocol (TCP) packets, in accordance with the embodiment of the present disclosure.

At step 302, the method 300 includes receiving a TCP packet from the one or more initiator (attacker) devices 116, where the input TCP packet comprises the initiator of communication (TCP-SYN). At step 304, the method 300 includes performing a DARK IP lookup for a received packet by matching the destination address of the received packet with the plurality of IP addresses stored in the dark IP pool. At step 306, the method 300 includes forwarding information base table for performing a DARK IP lookup. The destination address of the packet is matched against the routing information present in a Forward Information Base (FIB) table for the incoming packet.

At step 308, the method 300 includes modifying a “flag” and a “type” of a received packet in a socket buffer (SKB) to “local” in case the received packet is destined for a dark IP. At step 310, the method 300 includes modifying a “flag” and a “type” of a received packet routing entry associated with the SKB present in packet header, to “local” in case the received packet is destined for the plurality of dark IP addresses. At step 312, the method 300 includes creating a socket. At step 314, the method 300 includes initiating hash level comparison. At step 316, the method 300 includes matching hash values of all interfaces IPs with destination IP of the received packets.

At step 318, the method 300 includes determining an outbound interface, by circumnavigating a hash comparison with a network interface IP address for creating a network socket corresponding to the retrieved outbound interface IP addresses, to send the response packet for a received request packet. At step 320, the method 300 includes outputting, the response packet back to the one or more initiator (attacker) devices 116 initiating the request packet. At step 322, the method 300 includes receiving an acknowledgement packet from the one or more initiator (attacker) devices 116 to complete the 3-way handshake. The method 300 includes modifying the network stack algorithms of the kernel to process the incoming darknet traffic. The algorithm modifications at the kernel network stack allows the method 300 to actively engage with the external threat actors who are sending the probing packets (connection initiation or TCP-SYN) to the range of unused IP addresses.

### Exemplary Scenario-1:

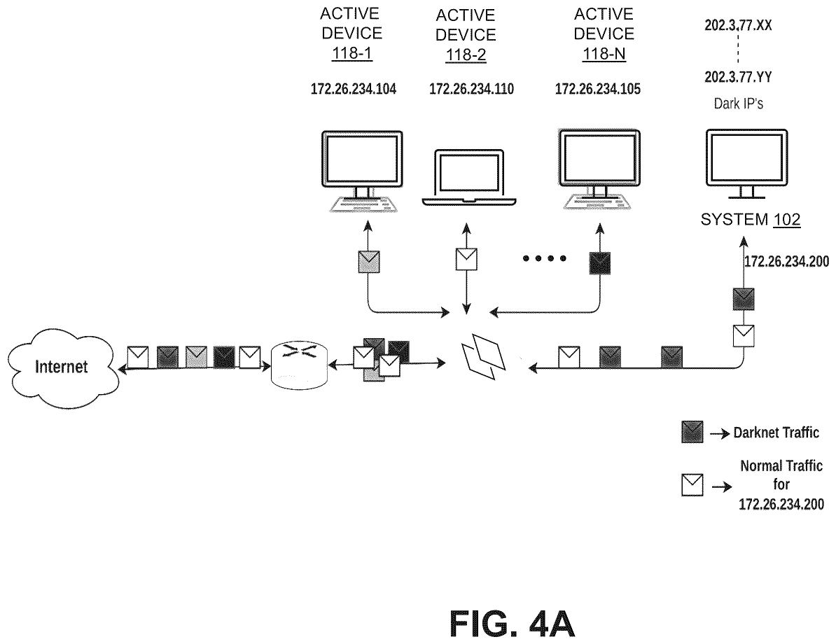

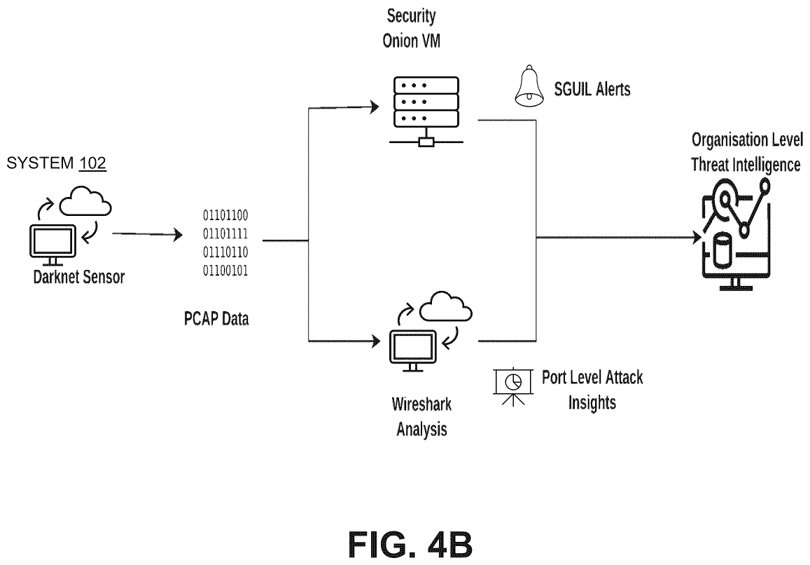

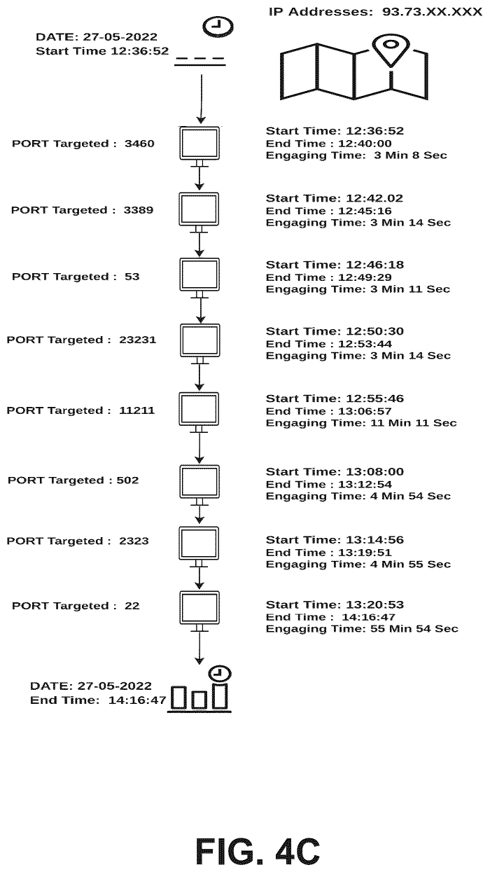

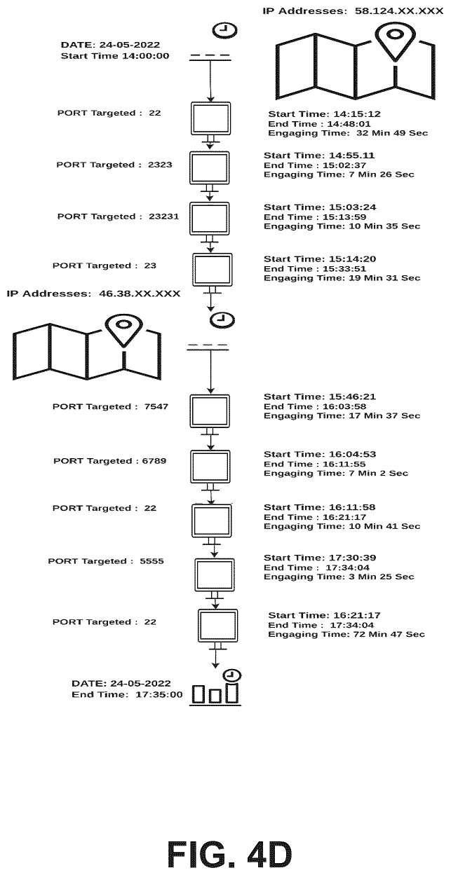

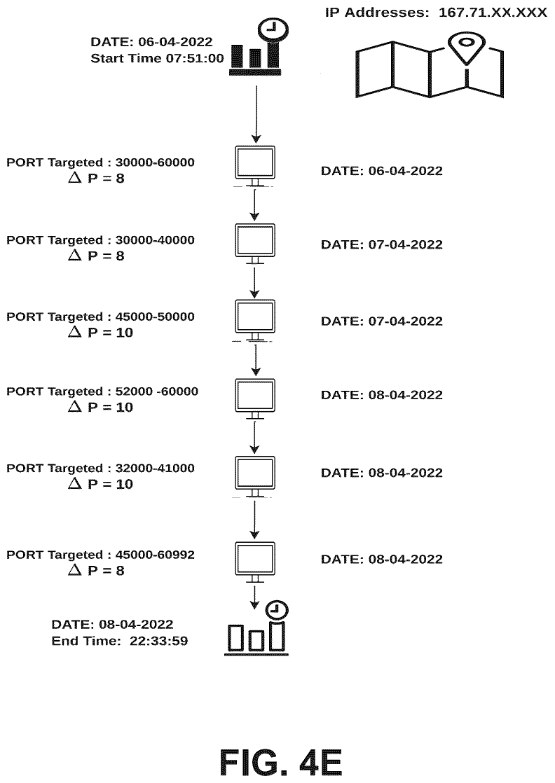

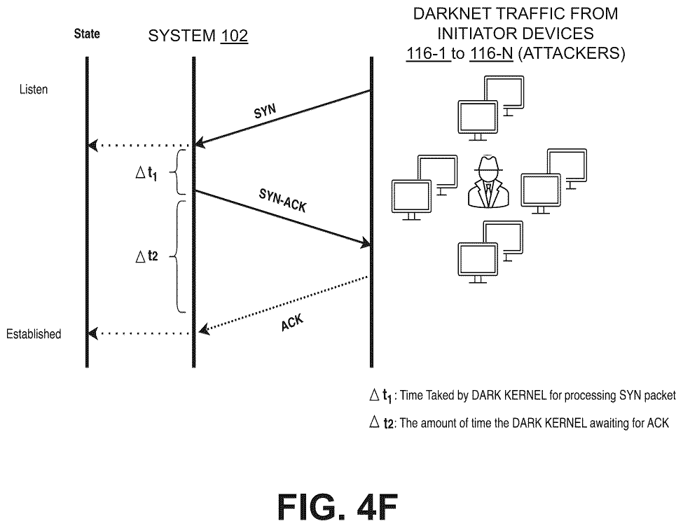

FIG. 4A illustrates an exemplary schematic diagram representation of implementing darknet kernel in an organization, in accordance with the embodiment of the present disclosure. Consider an experimental setup of the dark kernel for gathering darknet data from a network with other systems in an organization, as depicted in FIG. 4A. The system 102 is implemented using a modified kernel that responds to all traffic (an address resolution protocol (ARP), an internet protocol (IP), a transmission control protocol (TCP), an internet control message protocol (ICMP), and the like.) destined for dark IP addresses. Consider, four class-C public unused IP addresses may be used as dark IP addresses, and a router may be configured to transmit darknet data to the switch for these addresses. The system 102 receives its first address resolution protocol (ARP) query, and as a result of the kernel modifications, the system 102 responds to ARP requests, allowing darknet traffic from the Internet to route towards it. For example, data may be captured for e.g., 37 days using the four unused IP addresses, resulting in 275 GB of raw PCAP data. The statistics indicates that DARK-IP4 has the highest traffic engagement. The TCP is the dominant protocol, accounting for e.g., 68.54% of the total packets captured at the DARK-KERNEL, followed by user datagram protocol (UDP) with e.g., 18.87%, and ICMP with 3.72%. This aligns with conventional research statistics on darknet monitoring, which show that TCP is the major target of cyber-attacks.

In accordance with the present disclosure, a custom set of shell scripts is developed to utilize e.g., t-shark for filtering TCP packets involved in establishing a 3-way handshake (3WHS) with the system 102. Out of the total TCP traffic packets constituting 68.54%, only 16.6% involved in the 3WHS. Further, it can be inferred that the number of IPs involved in these 3WHS packets is approximately 0.1 million, which is roughly 25% of the total IPs. Hence, the present work focuses on analyzing this 16.6% of packets and the approximately 0.1 million actively engaging IPs associated with our dark IPs.

### Exemplary Scenario-2:

FIG. 4B illustrates an exemplary flow diagram representation of a method for obtaining threat Intelligence from an implemented dark kernel in an organization, in accordance with the embodiment of the present disclosure. Consider a scenario of validating incoming traffic and generating threat alerts for analysis and attack profiling by deploying dark kernel at the organization level. To achieve this objective, the system 102 performs two types of analysis on the captured traffic from dark-kernel, as illustrated in FIG. 4B. Firstly, the system uses network security analyzing techniques such as a security Onion®, a Linux® distribution that identifies intrusions, monitors network security, and manages logs [27]. It comprises various security tools, including for example, Snort®, Suricata®, Bro®, OSSEC®, Sguil®, Squert®, ELSA®, Xplico®, and Network Miner, based on Ubuntu®. The security onion seamlessly functions as a network and host-based intrusion detection system. The system 102 uses NIDS capabilities of security onion. Use Sguil®, which employs Snort or Suricata and Bro at the backend, to process our captured PCAP data, which fingerprints, detects abnormal or suspicious traffic, and generates corresponding alerts. The system 102 uses custom-written Wireshark filters to perform port analysis on popular ports. The system 102 systematically maps the geolocation of initiator devices 116 targeting the popular ports of the one or more dark IP addresses and calculates the average engagement time for each port of the one or more dark IP addresses.

Moreover, threat profiling is a powerful technique to identify the attacker's motivations, exchange threat knowledge, and create response strategies for an anticipated future incident. The system 102 provides security onion-based analysis and port-level insights to identify attack patterns from the data captured at dark-kernel. This enables the system 102 to predict the behavior of attackers more definitively and estimate the threat level posed by various groups of attackers targeting a particular organization.

In the alert-based analysis, the system 102 uses the security onion-based approach to generate alerts from the captured PCAP data. The top 7 threat events were identified and listed in Table 1 below:

TABLE 1

| | SGUIL | Number of | | Geo-Location of |
|---|---|---|---|---|
| | Event | Attacking | Packets | Attack Origin |
| Threat | Message | IPs | Received | initiator devices |
| T1 | Unusual Port | 3516 | 47378 | Russia, Pakistan, |
| | 445 traffic | | | Turkey |
| | Potential | | | |
| | Scan or | | | |
| | Infection | | | |
| T2 | Suspicious | 3885 | 1281165 | U.S, China, |
| | inbound to | | | Taiwan, Russia |
| | MSSQL, | | | |
| | MySQL, | | | |
| | Postgre SQL | | | |
| | port 1433, | | | |
| | 5432, 3306 | | | |
| T3 | LibSSH | 2776 | 1034850 | South Korea, U.S, |
| | Based | | | China |
| | Frequent | | | |
| | SSH | | | |
| | Connections | | | |
| | Likely | | | |
| | BruteForce | | | |
| | Attack | | | |
| T4 | Behavioral | 359 | 2722 | U.S, Venezuela, |
| | Unusual Port | | | Belgium |
| | 139 traffic | | | |
| | Potential | | | |
| | Scan or | | | |
| | Infection | | | |
| T5 | Potential | 553 | 83782 | U.S, Brazil, South |
| | VNC Scan | | | Korea |
| | 5800- | | | |
| | 5820,5900- | | | |
| | 5920 | | | |
| T6 | MS Terminal | 1870 | 945049 | Nepal, Pakistan, |
| | Server Traffic | | | U.S, Bangladesh |
| | on Non- | | | |
| | standard Port | | | |
| | (3389) | | | |

For each event, the system 102 analyzes the corresponding IP addresses and packets received at the socket. A detailed analysis of threat alerts T1 and T6 is provided below:

Threat alert T1 indicates unusual traffic on Port 445, which is commonly used by the SMB service. The traffic originates mainly from Pakistan, Russia, and Turkey, and analysis revealed that ransomware gangs exploit this port to propagate their attacks. The secondary infection stage of ransomware exploits the SMB service on port 445 to behave more like a worm, propagating itself on all computers it can access. Additionally, certain APT groups are compromising small office/home office (SOHO) routers through remote command injection on SMB ports to spread malware. It is observed that there is high traffic on this port, with a cumulative average engagement time of 17.6 hours across four dark IPs.

Threat alert T2 indicates suspicious inbound traffic on ports 1433, 5432, and 3306 used by MS SQL, MySQL, and PostgreSQL database engines, respectively. It is observed that traffic from various countries, including the United States, China, Taiwan, and Russia. Analysis revealed that the SQLSnake worm performs brute-force password attempts against the SQL Server administrator's account. Fancy Bear (APT-28) gang also monitors the internet for vulnerable devices operating on port 1433 to install a kernel module rootkit or use them as C2C servers for their campaigns. Attackers attempt to compromise PostgreSQL/MySQL servers for privilege escalation and denial of service attacks on ports 3306 and 5432. Interestingly, we also observed traffic from PONYNET, a popular US hosting provider for various malware families. The cumulative average engagement time for these ports was 10, 18, and 15.25 hours across four dark IPs.

Threat alert T3 has been issued due to the frequent SSH connections detected on our dark IPs, which are likely to be a brute force attack. Attackers often target port 22 for gaining initial access to the system by conducting brute force attacks on login credentials. Analysis indicates that most of the attackers use “libssh 1.8.0” (version less than 1.8.1) during the handshake, which exposes the remote system to integer overflow attacks based on the vulnerability CVE-2019-3855. We have observed this activity primarily from South Korea, the U.S, China, and Russia. The cumulative average engagement time for four dark IPs is 32.5 hours.

Threat alert T4 has been raised due to unusual port 139 traffic observed on our dark IPs, which could potentially be a scan or infection attempt. Port 139 is frequently targeted by attackers, and the outdated NetBIOS protocol used for communication between Windows computers makes it vulnerable to exploits like WannaCry Ransomware. Security researchers have noted that an SMB-listening device on an open, unfiltered Internet can be hacked within three minutes. We have detected this activity from the U.S. Belgium, and Venezuela. The cumulative average engagement time for four dark IPs is 23 hours.

A potential VNC scan T5 on dark IPs, with attackers attempting to access ports 5800-5820 and 5900-5920. Desktop sharing services such as VNC are often targeted by hackers due to their well-known default ports. These services are susceptible to brute force attacks, and attackers can also execute malware with privileged capabilities by exploiting the vulnerability CVE-2018-11458 through port 5900. We have observed traffic primarily originating from the U.S, Brazil, and South Korea. The cumulative average engagement time for four dark IPs is 23.06 hours. Further, MS Terminal Server traffic on non-standard port 3389 (T6), which could potentially lead to remote code execution. Misconfigurations and improper implementations of Microsoft's Remote Desktop Protocol (RDP) make it vulnerable to attacks. The BlueKeep vulnerability (CVE-2019-0708) has been discovered in RDP implementation, which allows attackers to execute remote code by connecting to an unpatched target machine through RDP port. We have detected this traffic mainly from Nepal, Pakistan, the U.S, and Bangladesh. The cumulative average engagement time for four dark IPs is 28.5 hours.

Tor-based threat alerts: attackers often use Tor to conceal their identity while performing malicious cyber activities that compromise the confidentiality, integrity, and availability of an organization's information systems and data. These activities include reconnaissance, system penetration, exfiltration and data manipulation, DOS attacks, and ransomware payload distribution. The use of Tor poses a significant threat to organizations, and tracking Tor-based threat alerts is critical for acquiring organization-level threat intelligence. Recent studies indicate that the majority of these attacks from Tor exit nodes generate large volumes of traffic, such as Denial-of-Service attacks. Identifying traffic from Tor exit nodes is a simple solution to this issue, allowing for early detection of cyber-attacks. The system 102 analyzed Sguil's Tor-based alerts and mapped the geolocation of Tor exit node IP addresses using the official Tor project exit node list. The system 102 calculated the attack engagement time for each dark IP and discovered malicious traffic originating from multiple exit and relay nodes targeting specific ports, such as 9200 (Elastic Search), 556 (Remote File Sharing), 543 (Kerberos Login), 5900 (VNC), and 587 (SMTP). Table 4 illustrates the geolocation of six major Tor exit nodes and the services targeted in our organization. Most of the traffic originates from Germany, the United Kingdom, Bulgaria, France, Sweden, and the U.S. We observe that dark IP 2 has a higher average engagement time and number of bytes transmitted compared to Tor traffic, as shown in Table 2 below.

TABLE 2

| | Average | | |
|---|---|---|---|
| | Engagement | | |
| DARK | Time (In | Number of | Number of |
| IP | Seconds) | Packets | Bytes |
| IP1 | 47679.10 | 767 | 54065 |
| IP2 | 148729.03 | 2201 | 157702 |
| IP3 | 138102.03 | 460 | 34335 |
| IP4 | 112931 | 1959 | 136100 |

Port-based analysis: analyzing incoming traffic based on the destination port provides valuable information about the services targeted by attackers, allowing for the characterization of attack behavior. Understanding the targeted ports and the sequence of services targeted helps to understand the attacker's modus operandi. To extract the PCAP data specific to 18 popular ports in our analysis, we developed shell scripts. The script calculates the average engagement time for each dark IP for these 18 ports. The average engagement time metric measures the amount of time a particular IP actively interacts with dark IP, calculated by dividing the sum of the duration of sessions for a specific port by the total number of sessions for that particular port.

$$Average Engagement Time ( Port ) = \frac{\sum ( {T}_{1}^{P} + {T}_{2}^{P} + I . + {T}_{N}^{p} )}{N} \qquad Equation 1$$

In the above equation1, the variable Tᵢ^{p} may refer to duration of one {Attack Session}, on a specific port ‘p’ of a dark IP, the variable ‘N’ may refer to total number attack sessions on a specific dark IP.

### Exemplary Scenario-3

FIGS. 4C-4E illustrate exemplary schematic diagram representations of attack timelines for a plurality of exemplary scenarios, in accordance with the embodiment of the present disclosure. In FIG. 4C, consider a threat analysis scenario-1 for highly unusual traffic originating from an IP located in Ukraine. The analysis of traffic patterns indicates that the IP targeted several ports over a span of approximately 2 hours, as depicted in FIG. 4C. The IP may be observed initially targeting windows services running on port 3460, which is used by the poison ivy remote access trojan to communicate with its command-and-control server. The IP may be established with 3-way handshake connections with DARK-KERNEL for nearly ˜3 minutes. Following this, the same IP targeted port 3389 (RDP service) for ˜3 minutes, and then targeted the popular SMB protocol by establishing 3-way handshake connections. Subsequently, the IP moved to a different set of ports that IoT and Cyber-Physical Systems use, including ports 23231, 11211, 502, and 2323. Port 23231 is used by the MIRAI IoT botnet to actively comprise devices for botnet activities, while port 11211 is used for Memcached services and can lead to massive amplification and reflective DDOS attacks with the UDP version of the port. Port 502 is a default Modbus service port widely used for SCADA systems. The IP was observed communicating on this port for nearly 5 minutes. Later, the IP established 3-way handshake connections with port 2323, which is also used by the MIRAI IoT botnet for victimizing the device to perform a botnet activity. Finally, many 3WHS being established with the ssh port for 55 minutes. Also, SSH key exchange and encrypted message communication after the 3WHS was established. Our analysis suggests that there is an attempt to brute force SSH service. Based on observations, inferring that this Ukrainian IP engaged with our DARK-KERNEL in an attempt to compromise widely used Windows services and later in CPs/IIoT domains. The present disclosure thus presents a threat analysis scenario that can provide better threat intelligence by correlating traffic insights using Wireshark to map the attacker's behavior and motives.

In scenario-2 depicted in FIG. 4D, observing traffic from South Korean and Russian IPs at different time periods. The engagement time for South Korean and Russian IP was about ˜1 hour and ˜2 hours, respectively. The attacker attempted to establish connections with ports 22, 2323, 23231, and 23, which is a clear indication of the South Korean IP trying to compromise our dark IP for MIRAI botnet activity. Similarly, a Russian IP targeted ports 7547, 6789, 5555, and 22 for almost 3 hours, indicating an attempt to compromise our DARK IP with a botnet malware. The uneven and non-synchronous time intervals between the connection establishments suggest that it is not an automated script or an already compromised bot scanning for vulnerable ports but an attacker attempting to initiate botnet activity.

In scenario-3 depicted in FIG. 4E, consider observations of suspicious traffic from an IP originating from the USA. The IP established a 3-way handshake with port 30000 and then incremented the port number with a specific value to establish 3-way handshakes with a range of ports. The pattern of incrementing port numbers with ΔP oscillating between 8 and 10 indicates an attempt to perform an automated scan of our DARK IP on a specific port range with a predefined pattern. The traffic apparently started again with port 30000, indicating the attacker's intention to perform repeated scans on our DARK IP.

FIG. 4F illustrates an exemplary timing diagram representation of a darknet kernel operation and transmission control protocol (TCP) states, in accordance with the embodiment of the present disclosure. The dark-kernel (e.g., system 102) is an active darknet sensor that listens to TCP ports and sends SYN-ACK packets to clients that request them. The performance of the DARK-KERNEL is evaluated by measuring the time taken to process incoming TCP-SYN packets and send response SYN-ACK packets. The DARK-KERNEL has a low Δt1 and a reasonable Δt2, which are achieved by modifying functions and sysctl parameters at the kernel level. The latency of the DARK-KERNEL ranges between 20 microseconds to 75 microseconds. To handle the number of TCP connections in the “SYN-Received” state, the limit for the number of TCP connections needs to be increased to 10240, and the value of the ‘top_synack_retries’ sysctl parameter is changed to 15. This allows the dark kernel to handle “half-opened connections” for a longer time. The dark-kernel system 102 responds to incoming TCP-SYN packets and establishes connections with dark IP addresses. The system 102 can handle a large number of half-opened connections and establish connections with incoming darknet traffic. The system 102 is evaluated with different applications such as sshd, telnet, and httpd, and the results show that the system 102 can handle up to 40960 TCP connections in the “SYN-received” state when all three applications are running simultaneously over four different ports. The system 102 is also observed to establish stable connections with different dark IP addresses over ports 22 and 23. The system 102 is considered robust and suitable for handling darknet traffic.

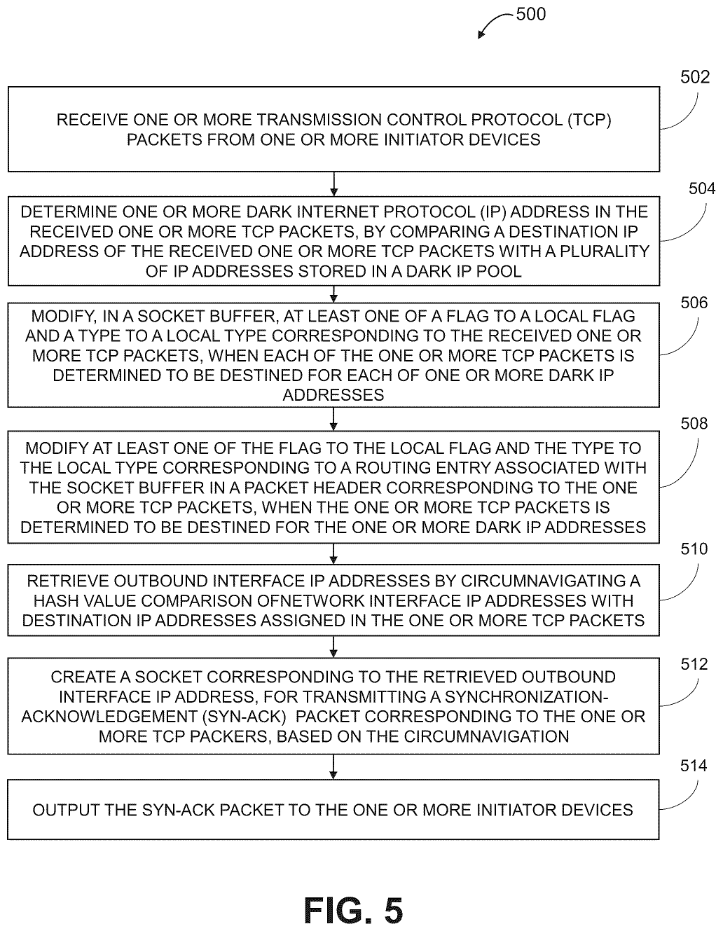

FIG. 5 illustrates a flow chart depicting a method 500 for kernel-level active darknet monitoring in the communication network 108, in accordance with the embodiment of the present disclosure.

At block 502, the method 500 may include receiving, by the one or more hardware processors 110 associated with the system 102, one or more transmission control protocol (TCP) packets from one or more initiator devices 116. The one or more TCP packets comprises a synchronize packet (TCP-SYN) to initiate a connection with the system 102 and establish a communication channel.

At block 504, the method 500 may include determining, by the one or more hardware processors 110, one or more dark internet protocol (IP) address in the received one or more TCP packets, by comparing a destination IP address of the received one or more TCP packets with a plurality of IP addresses stored in a dark IP pool.

At block 506, the method 500 may include modifying, by the one or more hardware processors 110, in a socket buffer, at least one of a flag to a local flag and a type to a local type corresponding to the received one or more TCP packets, when each of the one or more TCP packets is determined to be destined for each of one or more dark IP addresses.

At block 508, the method 500 may include modifying, by the one or more hardware processors 110, at least one of the flag to the local flag and the type to the local type corresponding to a routing entry associated with the socket buffer in a packet header corresponding to the one or more TCP packets, when the one or more TCP packets is determined to be destined for the one or more dark IP addresses.

At block 510, the method 500 may include retrieving, by the one or more hardware processors 110, an outbound interface IP address by circumnavigating a hash value comparison of network interface IP addresses with destination IP addresses assigned in the one or more TCP packets.

At block 512, the method 500 may include creating, by the one or more hardware processors 110, a socket corresponding to the retrieved outbound interface IP addresses, for transmitting a synchronization-acknowledgement (SYN-ACK) packet corresponding to the one or more TCP packets, based on the circumnavigation. The system 102 is configured to monitor each of one or more dark IP addresses received through a network traffic, based on modifying at least one of the flag to the local flag and the type to the local corresponding to the one or more TCP packets determined to be destined for the one or more dark IP addresses.

At block 514, the method 500 may include outputting, by the one or more hardware processors 110, the SYN-ACK packet to the one or more initiator devices, wherein the one or more initiator devices 116 establish the communication channel by transmitting an acknowledgement (ACK) packet to the system 102, to establish a three-way handshake.

The method 500 may be implemented in any suitable hardware, software, firmware, or combination thereof. The order in which the method 500 is described is not intended to be construed as a limitation, and any number of the described method blocks may be combined or otherwise performed in any order to implement the method 500 or an alternate method. Additionally, individual blocks may be deleted from the method 500 without departing from the spirit and scope of the present disclosure described herein. Furthermore, the method 500 may be implemented in any suitable hardware, software, firmware, or a combination thereof, that exists in the related art or that is later developed. The method 500 describes, without limitation, the implementation of the system 102. A person of skill in the art will understand that method 500 may be modified appropriately for implementation in various manners without departing from the scope and spirit of the disclosure.

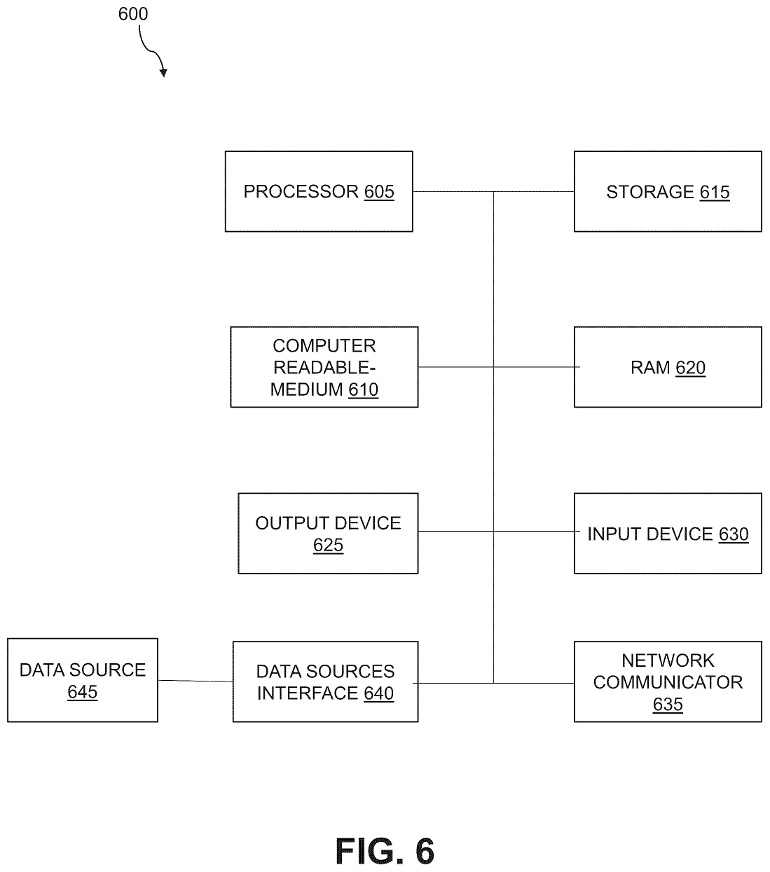

FIG. 6 illustrates an exemplary block diagram representation of a hardware platform 600 for implementation of the disclosed system 102, according to an example embodiment of the present disclosure. For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables which may be used to execute the system 102 or may include the structure of the hardware platform 600. As illustrated, the hardware platform 600 may include additional components not shown, and some of the components described may be removed and/or modified. For example, a computer system with multiple GPUs may be located on external-cloud platforms including Amazon Web Services, or internal corporate cloud computing clusters, or organizational computing resources.

The hardware platform 600 may be a computer system such as the system 102 that may be used with the embodiments described herein. The computer system may represent a computational platform that includes components that may be in a server or another computer system. The computer system may be executed by the processor 605 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 605 that executes software instructions or code stored on a non-transitory computer-readable storage medium 610 to perform methods of the present disclosure. The software code includes, for example, instructions to gather data and analyze the data. For example, the plurality of modules 114 includes a packet receiving module 206, a dark internet protocol (IP) address determining module 208, a flag and type modifying module 210, an outbound interface address retrieving module 212, a socket creating module 214, a packet outputting module 216, a darknet monitoring module 218, and a traffic segregating module 220.

The instructions on the computer-readable storage medium 610 are read and stored the instructions in storage 615 or random-access memory (RAM). The storage 615 may provide a space for keeping static data where at least some instructions could be stored for later execution. The stored instructions may be further compiled to generate other representations of the instructions and dynamically stored in the RAM such as RAM 620. The processor 605 may read instructions from the RAM 620 and perform actions as instructed.

The computer system may further include the output device 625 to provide at least some of the results of the execution as output including, but not limited to, visual information to users, such as external agents. The output device 625 may include a display on computing devices and virtual reality glasses. For example, the display may be a mobile phone screen or a laptop screen. GUIs and/or text may be presented as an output on the display screen. The computer system may further include an input device 630 to provide a user or another device with mechanisms for entering data and/or otherwise interacting with the computer system. The input device 630 may include, for example, a keyboard, a keypad, a mouse, or a touchscreen. Each of these output devices 625 and input device 630 may be joined by one or more additional peripherals. For example, the output device 625 may be used to display the results such as bot responses by the executable chatbot.

A network communicator 635 may be provided to connect the computer system to a network and in turn to other devices connected to the network including other clients, servers, data stores, and interfaces, for example. A network communicator 635 may include, for example, a network adapter such as a LAN adapter or a wireless adapter. The computer system may include a data sources interface 640 to access the data source 645. The data source 645 may be an information resource. As an example, a database of exceptions and rules may be provided as the data source 645. Moreover, knowledge repositories and curated data may be other examples of the data source 645.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising.” “having,” “containing,” and “including.” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

What is claimed is:

1. A computer-implemented system for kernel-level active darknet monitoring in a communication network, the computer-implemented system comprising:
one or more hardware processors;
a memory coupled to the one or more hardware processor, wherein the memory comprises a plurality of modules in form of programmable instructions executable by the one or more hardware processors, wherein the plurality of modules comprises:
a packet receiving module configured to receive one or more transmission control protocol (TCP) packets from one or more initiator devices, wherein the one or more TCP packets comprises a synchronize packet (TCP-SYN) to initiate a connection with the system and establish a communication channel;
a dark internet protocol (IP) address determining module configured to determine one or more dark internet protocol (IP) address in the received one or more TCP packets, by comparing a destination IP address of the received one or more TCP packets with a plurality of IP addresses stored in a dark IP pool;
a flag and type modifying module configured to:
modify, in a socket buffer, at least one of a flag to a local flag and a type to a local type corresponding to the received one or more TCP packets, when each of the one or more TCP packets is determined to be destined for each of one or more dark IP addresses;
modify at least one of the flag to the local flag and the type to the local type corresponding to a routing entry associated with the socket buffer in a packet header corresponding to the one or more TCP packets, when the one or more TCP packets is determined to be destined for the one or more dark IP addresses;
an outbound interface address retrieving module configured to retrieve outbound interface IP addresses by circumnavigating a hash value comparison of network interface IP addresses with destination IP addresses assigned in the one or more TCP packets;
a socket creating module configured to create a socket corresponding to the retrieved outbound interface IP addresses for transmitting a synchronization-acknowledgement (SYN-ACK) packet corresponding to the one or more TCP packets, based on the circumnavigation, wherein the system is configured to monitor each of one or more dark IP addresses received through a network traffic, based on modifying at least one of the flag to the local flag and the type to the local corresponding to the one or more TCP packets determined to be destined for the one or more dark IP addresses; and
a packet outputting module configured to output the SYN-ACK packet to the one or more initiator devices, wherein the one or more initiator devices establish the communication channel by transmitting an acknowledgement (ACK) packet to the system, to establish a three-way handshake.

2. The system of claim 1, wherein to modify at least one of the flag to the local flag and the type to the local corresponding to the one or more TCP packets, the plurality of modules comprises:
a darknet monitoring module configured to monitor kernel-level active darknet destined to the one or more dark IP addresses.

3. The system of claim 1, wherein the plurality of modules further comprises:
a traffic segregating module configured to segregate a backscattered traffic of the SYN-ACK packet and an active attacker in the one or more initiator devices.

4. The system of claim 1, wherein the plurality of modules further comprises:
an endpoint creating module configured to create one or more phantom responder endpoints to one or more attacks using the one or more dark IP addresses;
a machine simulating module configured to simulate active machines corresponding to the active device for sending the response packets;
an activity deception module configured to perform deception of the one or more initiator devices performing a series of malicious operations in an attempt to compromise the one or more dark IP addresses, using the simulated active devices; and
a data accumulating module configured to accumulate pre-determined threat intelligence data corresponding to the one or more attacks by the one or more initiator devices, and a modus operandi data corresponding to the one or more attacks.

5. The system of claim 4, wherein to accumulate the modus operandi data corresponding to the one or more attacks, the plurality of modules further comprises:
a data monitoring module configured to monitor packet capture (PCAP) data for determining one or more geo-locations of the one or more initiator devices;
a data analyzing module configured to analyze the data to identify attack patterns and a plurality of threat levels posed by the one or more initiator devices; and
a report generating module configured to generate a modus operandi report corresponding to the identified attack patterns and the plurality of threat levels.

6. The system of claim 1, wherein the plurality of modules further comprises:
a packet data accumulating module configured to accumulate PCAP data associated with the active device and the one or more initiator devices;
a data analyzing module configured to analyze the accumulated PCAP data using a network security analyzing technique;
an alert generating module configured to generate one or more alerts using the network security analyzing technique, based on the analyzed PCAP data; and
a prioritized alert determining module configured to determine one or more prioritized alerts in the generated one or more alerts, for the kernel-level active darknet monitoring.

7. The system of claim 6, wherein the PCAP data comprises information corresponding to at least one of network protocols, source IP addresses, destination IP addresses, outbound interface IP addresses, network interface IP addresses, port numbers, and payload of the one or more TCP packets.

8. The system of claim 1, wherein the plurality of modules further comprises:
a geolocation mapping module configured to map one or more geolocations of the one or more initiator devices targeting the one or more dark IP addresses targeting one or more pre-defined ports associated with the active device;
an engage-time calculating module configured to calculate an average engagement time of the one or more initiator devices with each of the one or more pre-defined ports of the one or more dark IP addresses;
an attack determining module configured to determine the one or more attacks based on the calculated average engagement time of the one or more initiator devices with each of the one or more pre-defined ports of the one or more dark IP addresses;
an attacker profiling module configured to profile the one or more attacks from the one or more initiator devices based on determining the one or more attacks; and
a warning generating module configured to generate one or more warnings corresponding to the profiled one or more attacks.

9. A computer-implemented method for kernel-level active darknet monitoring in a communication network, the computer-implemented method comprising:
receiving, by one or more hardware processors associated with a system, one or more transmission control protocol (TCP) packets from one or more initiator devices, wherein the one or more TCP packets comprises a synchronize packet (TCP-SYN) to initiate a connection with the system and establish a communication channel;
determining, by the one or more hardware processors, one or more dark internet protocol (IP) address in the received one or more TCP packets, by comparing a destination IP address of the received one or more TCP packets with a plurality of IP addresses stored in a dark IP pool;
modifying, by the one or more hardware processors, in a socket buffer, at least one of a flag to a local flag and a type to a local type corresponding to the received one or more TCP packets, when each of the one or more TCP packets is determined to be destined for each of one or more dark IP addresses;
modifying, by the one or more hardware processors, at least one of the flag to the local flag and the type to the local type corresponding to a routing entry associated with the socket buffer in a packet header corresponding to the one or more TCP packets, when the one or more TCP packets is determined to be destined for the one or more dark IP addresses;
retrieving, by the one or more hardware processors, outbound interface IP addresses by circumnavigating a hash value comparison of network interface IP addresses with destination IP addresses assigned in the one or more TCP packets;
creating, by the one or more hardware processors, a socket corresponding to the retrieved outbound interface IP addresses, for transmitting a synchronize-acknowledgement (SYN-ACK) packet corresponding to the one or more TCP packets, based on the circumnavigation, wherein the each of one or more dark IP addresses received through a network traffic is monitored based on modifying at least one of the flag to the local flag and the type to the local corresponding to the one or more TCP packets determined to be destined for the one or more dark IP addresses; and
outputting, by the one or more hardware processors, the SYN-ACK packet to the one or more initiator devices, wherein the one or more initiator devices establish the communication channel by transmitting an acknowledgement (ACK) packet to the system, to establish a three-way handshake.

10. The method of claim 9, wherein modifying at least one of the flag to the local flag and the type to the local corresponding to the one or more TCP packets, further comprises:
active, by the one or more hardware processors, kernel-level darknet monitoring for the traffic destined to the one or more dark IP addresses.

11. The method of claim 9 further comprising:
segregating, by the one or more hardware processors, a backscattered traffic of the SYN-ACK packet and an active attacker in the one or more initiator devices.

12. The method of claim 9 further comprising:
creating, by the one or more hardware processors, one or more phantom responder endpoints to one or more attacks using the one or more dark IP addresses;
simulating, by the one or more hardware processors, the active devices for sending the response packets;
performing, by the one or more hardware processors, deception of the one or more initiator devices performing a series of malicious operations in an attempt to compromise the one or more dark IP addresses, using the simulated active devices; and
accumulating, by the one or more hardware processors, pre-determined threat intelligence data corresponding to the one or more attacks by the one or more initiator devices, and a modus operandi data corresponding to the one or more attacks.

13. The method of claim 12, wherein accumulating the modus operandi data corresponding to the one or more attacks, further comprises:
monitoring, by the one or more hardware processors, the PCAP data for determining one or more geo-locations of the one or more initiator devices;
analyzing, by the one or more hardware processors, the data to identify attack patterns and a plurality of threat levels posed by the one or more initiator devices; and
generating, by the one or more hardware processors, a modus operandi report corresponding to the identified attack patterns and the plurality of threat levels.

14. The method of claim 9 further comprising:
accumulating, by the one or more hardware processors, packet capture (PCAP) data associated with the active device and the one or more initiator devices;
analyzing, by the one or more hardware processors, the accumulated PCAP data using a network security analyzing technique;
generating, by the one or more hardware processors, one or more alerts using the network security analyzing technique, based on the analyzed PCAP data; and
determining, by the one or more hardware processors, one or more prioritized alerts in the generated one or more alerts, for the active darknet monitoring.

15. The method of claim 14, wherein the PCAP data comprises information corresponding to at least one of network protocols, source IP addresses, destination IP addresses, outbound interface IP addresses, network interface IP addresses, port numbers, and payload of the one or more TCP packets.

16. The method of claim 9 further comprising:
mapping, by the one or more hardware processors, one or more geolocations of the one or more initiator devices targeting one or more pre-defined ports associated with the one or more dark IP addresses;
calculating, by the one or more hardware processors, an average engagement time of the one or more dark IP addresses with each of the one or more pre-defined ports;
determining, by the one or more hardware processors, the one or more attacks based on the calculated average engagement time of the one or more initiator devices with each of the one or more pre-defined ports of the one or more dark IP addresses;
profiling, by the one or more hardware processors, the one or more attacks from the one or more initiator devices based on determining the one or more attacks; and
generating, by the one or more hardware processors, one or more warnings corresponding to the profiled one or more attacks.

17. A non-transitory computer-readable storage medium having programmable instructions stored therein, that when executed by one or more hardware processors, cause the one or more hardware processors to:
receive one or more transmission control protocol (TCP) packets from one or more initiator devices, wherein the one or more TCP packets comprises a synchronize packet (TCP-SYN) to initiate a connection with the system and establish a communication channel;
determine one or more dark internet protocol (IP) address in the received one or more TCP packets, by comparing a destination IP address of the received one or more TCP packets with a plurality of IP addresses stored in a dark IP pool;
modify, in a socket buffer, at least one of a flag to a local flag and a type to a local type corresponding to the received one or more TCP packets, when each of the one or more TCP packets is determined to be destined for each of one or more dark IP addresses;
modify at least one of the flag to the local flag and the type to the local type corresponding to a routing entry associated with the socket buffer in a packet header corresponding to the one or more TCP packets, when the one or more TCP packets is determined to be destined for the one or more dark IP addresses;
retrieve outbound interface IP addresses by circumnavigating a hash value comparison of network IP addresses with destination IP addresses assigned in the one or more TCP packets;
create a socket corresponding to the retrieved outbound interface IP addresses, for transmitting g a synchronization-acknowledgement (SYN-ACK) packet corresponding to the one or more TCP packets, based on the circumnavigation, wherein the each of one or more dark IP addresses received through a network traffic is monitored based on modifying at least one of the flag to the local flag and the type to the local corresponding to the one or more TCP packets determined to be destined for the one or more dark IP addresses; and
output the SYN-ACK packet to the one or more initiator devices, wherein the one or more initiator devices establish the communication channel by transmitting an acknowledgement (ACK) packet to the system, to establish a three-way handshake.

18. The non-transitory computer-readable storage medium of claim 17, wherein to modify at least one of the flag to the local flag and the type to the local corresponding to the one or more TCP packets, the one or more hardware processors is configured to:
active darknet monitor for the traffic destined to the one or more dark IP addresses.

19. The non-transitory computer-readable storage medium of claim 17, wherein to modify at least one of the flag to the local flag and the type to the local corresponding to the one or more TCP packets, the one or more hardware processors is further configured to:
monitor kernel-level active darknet destined to the one or more dark IP addresses.

20. The non-transitory computer-readable storage medium of claim 17, wherein the one or more hardware processors is further configured to:
segregate a backscattered traffic of the SYN-ACK packet and an active attacker in the one or more initiator devices.
